(19) United States
(12) Patent Application Publication
(10) Pub. No.: US 2017/0221647 A1
(43) Pub. Date: Aug. 3, 2017

(54) METHOD AND DEVICE FOR SEALING AN ELECTROCHEMICAL CELL

(71) Applicant: Robert Bosch GmbH, Stuttgart (DE)

(72) Inventors: Bernd Schumann, Rutesheim (DE); Joerg Thielen, Stuttgart (DE)

(73) Assignees: Robert Bosch GmbH, Stuttgart (DE); Robert Bosch GmbH, Stuttgart (DE)

(21) Appl. No.: 15/305,135

(22) PCT Filed: Apr. 7, 2015
(86) PCT No.: PCT/EP2015/057515

§ 371 Date: Oct. 19, 2016

(30) Foreign Application Priority Data
Apr. 23, 2014 (DE) 102014207616.1

(51) Int. Cl. H01G 11/80; H01G 11/84; H01M 6/00; H01M 6/02; H01M 2/36; H01M 10/04

(52) U.S. Cl. CPC H01G 11/80; H01M 2/361; H01M 2/362; H01M 10/0404; H01M 10/0481; H01M 6/005; H01M 6/02; H01G 11/84

(57) ABSTRACT

A device for sealing an electrochemical cell including a carrier on which an anode is situated and a separator situated between the anode and a cathode, having an elastic connection of the carrier and the separator, an action of force on the separator, caused by a change in volume of the anode, being capable of being absorbed by the elastic connection of the carrier and the separator. In addition, a corresponding method for sealing an electrochemical cell is described.

### FIELD

The present invention relates to a method and a device for sealing an electrochemical cell.

### BACKGROUND INFORMATION

Electrochemical cells, in particular lithium-ion cells, are currently used in a large number of products as energy storage devices. These can be realized as energy storage devices for current from solar cells or wind power plants, for vehicles and electronic devices.

German Patent Application No. DE 10 2012 212 463 A1 describes a method for sealing an electrochemical cell including a housing and an electrode stack situated inside the housing. The method includes a filling of an electrolyte fill opening formed in the housing with an adhesive, hardening of the adhesive, and vapor deposition of a metallic layer on the hardened adhesive.

### SUMMARY

The present invention creates a device for sealing an electrochemical cell including a carrier on which an anode is situated and a separator situated between the anode and a cathode. The device for sealing the electrochemical cell has means for the elastic connection of the carrier and the separator, an action of force on the separator, caused by a change in volume of the anode, being capable of being absorbed by the means for the elastic connection of the carrier and separator.

In addition, the present invention creates a method for sealing an electrochemical cell including a carrier on which an anode is situated and a separator situated between the anode and a cathode. The method includes an elastic connection of the carrier and separator, an action of force on the separator, caused by a change in volume of the anode, being absorbed by means for the elastic connection of the carrier and separator.

In accordance with the present invention, the use of an anode in an electrochemical cell in an elastically and tightly sealed electrolyte that is hydrostatically separated from a cathode is enabled. This is required in cells in which it is useful to provide the anode with a particular electrolyte and to provide the cathode with a different, or the same, electrolyte, and to separate these two spaces by a separator that is hydrostatically tight but ion-conducting.

For example in the lithium-sulfur accumulator cells, this separation brings it about that the lithium metal anode cannot react with reaction products or the materials of the cathode or the electrolyte at the cathode side. In lithium-air accumulator cells, in this way the cathode chamber, which can contain air or traces of water or other impurities, also cannot come into contact with the lithium metal anode, and thus also cannot initiate any disturbing reactions that attack, dissolve, or passivate the anode.

In particular, in accordance with the present invention, this space around the anode can expand or contract, as a result of electrochemical reactions at the anode or in the electrolyte, without resulting in cracks or breaks in the separator, which, as ion-conducting sealing membrane, separates the electrolyte space of the anode from the rest of the electrochemical cell.

In the discharging of the electrochemical cell, the anode material, for example in the case of a lithium-metal anode, is dissolved by more than two-thirds, and is transported through the separator to the cathode in the form of ions. In this way, the volume of the anode is reduced. Here, the separator moves toward the cell due to external pressure, and is moved hydrostatically toward the carrier. This change in volume and dimensions of the anode space is advantageously absorbed by the means for the elastic connection of the carrier and separator, and in this way the separator moves without pressure or tensile force.

Advantageous specific embodiments and developments result from the description herein with reference to the Figures.

Preferably, it is provided that the means for the elastic connection of carrier and separator are made of a plastic that has a closed porous region, or a porous region open only toward the interior of the anode and a nonporous region. The provision of a porous region has the advantage of good elasticity of the means for elastic connection of carrier and separator.

Preferably, it is in addition provided that the means for the elastic connection of carrier and separator are fashioned in open porous fashion at a side facing the electrochemical cell. Through the open porous realization of the means for elastic connection of carrier and separator on a side facing the electrochemical cell, an electrolyte filled into an anode space of the electrochemical cell can enter into the open-pored volume.

According to a further preferred embodiment, it is provided that the means for the elastic connection of carrier and separator are made wave-shaped on a side facing the electrochemical cell. The wave-shaped realization of the means for the elastic connection of carrier and separator on a side facing the electrochemical cell has the advantage that a region of a buckling of the separator is significantly broadened. The buckling of the separator at the respective transition areas between the separator and the means for the elastic connection of carrier and separator is thus less strong, because, due to the wave-shaped realization of the means for the elastic connection of carrier and separator, the buckling of the separator is broadened, so that the buckling is reduced by a factor of 2 to 10 per length unit of the separator. A tensile force occurring at an upper edge of the separator can also be reduced.

According to another preferred exemplary embodiment, it is provided that on a surface of the carrier there are situated a multiplicity of supporting elements, a distance between the respective supporting elements being from 10 to 100 μm, preferably 10 to 20 μm. The supporting elements have a stabilizing effect, and a space is created in which the electrolyte can adhere despite pressure on the cell. In the case in which the anode is dissolving, the separator advantageously comes to lie on the respective supporting elements.

Preferably, it is in addition provided that a thickness of the respective supporting element has a thickness of the means for the elastic connection of carrier and separator in the compressed state. In this way, a buckling of the separator can be completely avoided.

According to a further preferred exemplary embodiment, it is provided that an anode fashioned between the carrier and the separator is filled with an electrolyte, the anode space being capable of being filled in a vacuum or under reduced ambient pressure. In this way, no quantity of gas, or a very small quantity of gas under reduced pressure, is brought into the anode space. This contributes to an improved elasticity of the means for the elastic connection of carrier and separator.

According to a further preferred embodiment, it is provided that the means for the elastic connection of bearer and separator is respectively connected in media-tight fashion to the carrier and to the separator at their ends. Thus, the means for the elastic connection of carrier and separator have the function both of the elastic connection of the carrier and separator and of sealing the carrier and separator.

Preferably, it is additionally provided that the means for the elastic connection of carrier and separator have a gap-shaped hollow space that is capable of expansion when there is an expansion of the anode and is capable of compression when there is a reduction in size of the anode. The hollow space forms a reservoir for the electrolyte and a space that can expand when the anode expands and can contract when the anode becomes smaller. An advantage of this configuration is a smaller buckling of the separator, because the hollow space can guide the separator until it lies on the carrier, because the hollow space does not have to contain any supporting material.

According to a further preferred exemplary embodiment, it is provided that an anode space formed between the carrier and the separator is filled with an electrolyte in a vacuum or in a reduced ambient pressure. In this way, no quantity of gas, or a very small quantity of gas under reduced pressure, is brought into the anode space. This contributes to an improved elasticity of the means for the elastic connection of the carrier and separator.

The described embodiments and developments can be combined with one another in any desired manner.

Further possible embodiments, developments, and implementations of the present invention also include combinations not explicitly named of features of the present invention described above or in the following with regard to the exemplary embodiments.

### BRIEF DESCRIPTION OF THE DRAWINGS

The figures are intended to impart further understanding of the specific embodiments of the present invention. They illustrate specific embodiments and, in connection with the description, provide explanation of principles and designs of the present invention.

Other specific embodiments, and many of the named advantages, result with regard to the figures. The depicted elements of the figures are not necessarily shown to scale relative to one another.

FIG. 1 shows a perspective representation of a device according to the present invention for sealing an electrochemical cell according to a first specific embodiment of the present invention.

FIG. 2 shows an enlarged partial view of the device according to the present invention for sealing the electrochemical cell according to the first specific embodiment of the present invention.

FIG. 3 shows an enlarged partial view of the device according to the present invention for sealing the electrochemical cell according to the first specific embodiment of the present invention.

FIG. 4 shows a top view of a carrier according to the present invention of the electrochemical cell.

FIG. 5 shows a perspective view of the device for sealing the electrochemical cell according to a second specific embodiment of the present invention.

FIG. 6 shows a perspective view of the device for sealing the electrochemical cell according to a third specific embodiment of the present invention.

FIG. 7 shows a perspective view of the device for sealing the electrochemical cell according to a fourth specific embodiment of the present invention.

FIG. 8 shows a perspective view of the device for sealing the electrochemical cell according to a fifth specific embodiment of the present invention.

FIG. 9 shows a flow diagram of a method for sealing an electrochemical cell according to the first through fifth specific embodiments of the present invention.

### DETAILED DESCRIPTION OF EXAMPLE EMBODIMENTS

In the Figures, identical reference characters designate identical or functionally identical elements, assemblies, or components, unless otherwise indicated.

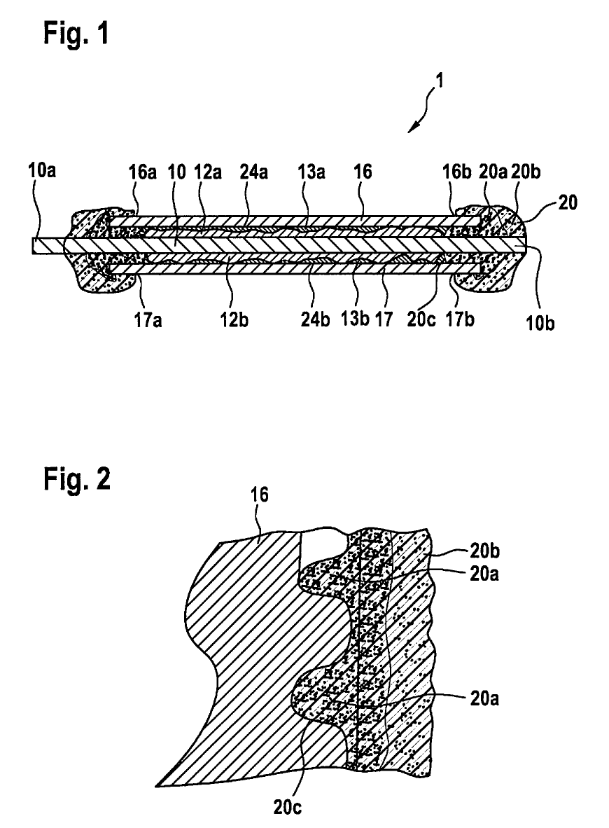

FIG. 1 shows a perspective representation of a device according to the present invention for sealing an electrochemical cell according to a first specific embodiment of the present invention.

The device for sealing an electrochemical cell 1 includes a carrier 10 on which an anode 12a, 12b is respectively situated on an upper side and lower side. The device for sealing electrochemical cell 1 has in addition a separator 16, 17 situated between anode 12a, 12b and a respective cathode (not shown in FIG. 1). An anode space 13a is formed between separator 16 and carrier 10. Anode space 13a is filled with an electrolyte 24a. An anode space 13b is formed between separator 17 and carrier 10. Anode space 13b is filled with an electrolyte 24b.

The device for sealing electrochemical cell 1 has means 20 for the elastic connection of carrier 10 and separator 16, 17. Means 20 for the elastic connection of carrier 10 and separator 16, 17 are made of a plastic. The plastic has a closed porous region 20a and a non-porous region 20b. Porous region 20a is situated on a side 20c facing electrochemical cell 1. Porous region 20a is made in open porous fashion on side 20c facing electrochemical cell 1. Alternatively, porous region 20a can also be made not in open porous fashion on side 20c facing electrochemical cell 1, having in particular fewer pores, less than 30% of the volume of region 20a.

Means 20 for the elastic connection of carrier 10 and separator 16, 17 are respectively connected in media-tight fashion with separator 16, 17 and with the carrier at their ends 10a, 10b, 16a, 16b, 17a, 17b. At its end 10a, carrier 10 extends past means 20 for the elastic connection of carrier 10 and separator 16, 17. Here, as a conductive carrier, carrier 10 offers an electrical contacting possibility that can be used for example as connecting element for a current collector of the electrochemical cell, e.g. as a weld contact to the anode. A sealing compound of means 20 for the elastic connection of carrier 10 and separator 16, 17 additionally seals the feedthrough of carrier 10 hermetically against the outer space. Alternatively, carrier 10 can also have a conductive lug as contact possibility. Carrier 10 can alternatively not be led out, or can be led out at both sides, as is appropriate for example in the case of high-power cells.

The sealing compound of means 20 for the elastic connection of carrier 10 and separator 16, 17 is connected to the separator and to carrier 10 at respective ends of separator 16, 17 and of carrier 10, in particular by gluing or fusing. Due to the formation of anodes 12a, 12b on carrier 10 at both sides, a high surface utilization can be achieved.

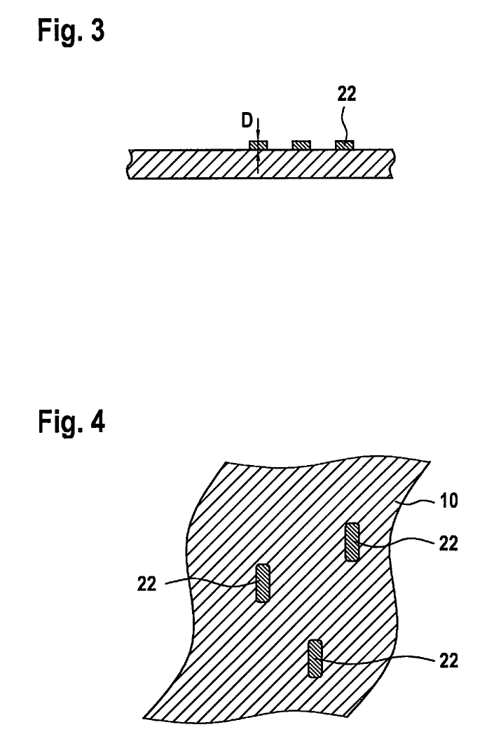

FIG. 2 shows an enlarged partial view of the device according to the present invention for sealing an electrochemical cell according to the first specific embodiment of the present invention.

Means 20 for the elastic connection of carrier 10 and separator 16, 17 are formed with a wave shape on side 20c facing electrochemical cell 1. Separator 16 and wave-shaped porous region 20a of means 20 for the elastic connection of carrier 10 and separator 16, 17 mesh with one another.

FIG. 3 shows an enlarged partial view of the device according to the present invention for sealing an electrochemical cell according to the first specific embodiment of the present invention.

A plurality of supporting elements 22 are situated on a surface of carrier 10. Supporting elements 22 have a spacing of from 10 to 100 μm, preferably 10 to 20 μm. A thickness D of the respective supporting element 22 has a thickness of means 20 for the elastic connection of carrier 10 and separator 16, 17 in the compressed state. Depending on the state of discharge of the electrochemical cell, a distance between the respective separator 16, 17 and carrier 10 varies. In the case of a discharged electrochemical cell, this spacing is minimal. In order to avoid a buckling of the separator in the case of a strong compression of means 20 for the elastic connection of carrier 10 and separator 16, 17, the respective supporting elements 22 are provided on the surface of carrier 10. Due to the provision of supporting elements 22, separator 16, 17 comes to lie against supporting elements 22 in the case of a dissolving anode. The distance between supporting elements 22 is dimensioned so as to be of the order of magnitude of a separator layer thickness, i.e. approximately 10 to 100 μm, in particular 10 to 20 μm.

FIG. 4 shows a top view of a carrier according to the present invention of the electrochemical cell.

Supporting elements 22 have an oblong shape. Alternatively, supporting elements 22 can also have some other suitable shape. Supporting elements 22 are uniformly distributed on the surface of carrier 10 in order to enable a uniform support surface for the respective separator 16, 17.

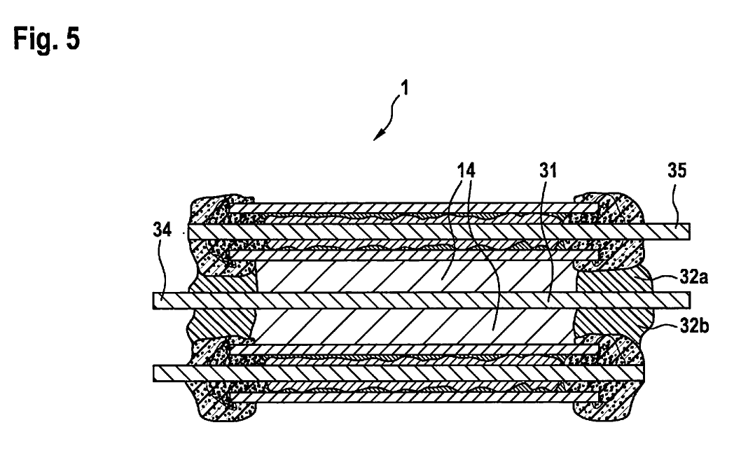

FIG. 5 shows a perspective view of the device for sealing an electrochemical cell according to a second specific embodiment of the present invention.

The device for sealing electrochemical cell 1 is shown in FIG. 5 having two anodes realized at both sides, and also to cathodes 14. Electrochemical cell 1 has in addition current conductors 34, 35 led out in alternating fashion. Likewise, two additional seals 32a, 32b are provided in an elastic manner, which seal a cathode current carrier 31 against the two adjacent separators. The unit shown in FIG. 5 is a repeating structure in which an anode-separator structure at both sides is laminated onto the cathode at both sides with sealing 32a, 32b.

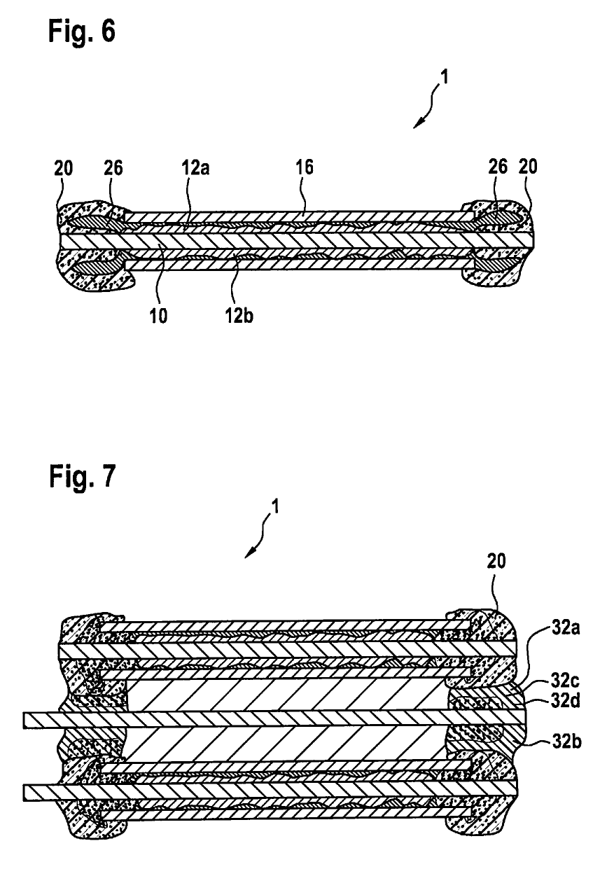

FIG. 6 shows a perspective view of the device for sealing an electrochemical cell according to a third specific embodiment of the present invention.

In FIG. 6, means 20 for the elastic connection of carrier 10 and separator 16, 17 have a closed porous foam structure. The porous foam structure is fashioned in the form of an elastic sealing compound, or a sealing profile, having in its interior a multiplicity of gap-shaped hollow spaces 26. The number of hollow spaces 26 can be adapted as needed. Hollow spaces 26 form a reservoir for the electrolyte, and form a space that can expand when there is expansion of the respective anode 12a, 12b, and can contract when there is a reduction in size of the anode, or anode layer.

FIG. 7 shows a perspective view of the device for sealing an electrochemical cell according to a fourth specific embodiment of the present invention.

In this embodiment, seals 32a, 32b in cathode spaces, having a porous structure, are also provided, formed in open porous fashion on a side facing electrochemical cell 1. In this way, electrolyte can be absorbed or released when the cathode structure expands or contracts during charging or discharging. In this way, an electrolyte reservoir can also be provided in order to additionally provide electrolyte in order to dissolve a reaction product in the cathode during charging or discharging in order to enable a higher kinetic characteristic. In addition, the expansion of the cathode or the contraction of the cathode is volumetrically compensated by the variable side sealing.

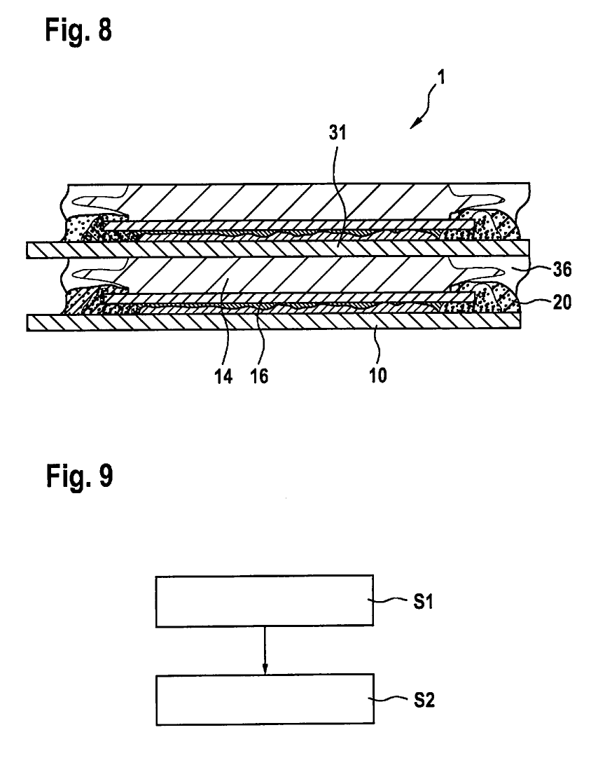

FIG. 8 shows a perspective view of the device for sealing an electrochemical cell according to a fifth specific embodiment of the present invention.

In FIG. 8, a lip seal, as shown already in FIG. 6 for the anodes 12a, 12b, is provided in the cathode space. Due to the fact that in addition to the upper side of an anode carrier a cathode structure can now also be attached tightly on the lower side, a new cell construction can be enabled so that there arises a cell structure that is easy to connect in series.

FIG. 9 shows a flow diagram of a method for sealing an electrochemical cell according to the first through fifth specific embodiments of the present invention.

The method for sealing an electric chemical cell 1, including a carrier 10 on which an anode 12a, 12b is situated and a separator 16, 17 situated between anode 12a, 12b and a cathode, includes an elastic connection S1 of carrier 10 and separator 16, 17, an action of force on separator 16, 17, caused by a change in volume of anode 12a, 12b, being absorbed by means 20 for the elastic connection of carrier 10 and separator 16, 17. The method additionally includes step S2, in which an anode space 13a, 13b formed between carrier 10 and separator 16, 17 is filled with an electrolyte 24a, 24b in a vacuum or under reduced ambient pressure. The filling of anode space 13a, 13b by electrolyte 24a, 24b takes place after the elastic connection S1 of carrier 10 and separator 16, 17 by means 20. Alternatively, the filling of anode space 13a, 13b with electrolyte 24a, 24b can also take place before the step of the elastic connection S1 of carrier 10 and separator 16, 17 by means 20.

Although the present invention has been described above on the basis of preferred exemplary embodiments, it is not limited thereto, but rather can be modified in many ways. In particular, the present invention can be modified in many ways without departing from the core of the present invention.

For example, means 20 for the elastic connection of carrier 10 and separator 16, 17 can have any suitable shape and thickness. In addition, the ratio of porous to non-porous regions of means 20 can be provided in a suitable manner.

1-11. (canceled)

12. A device for sealing an electrochemical cell including a carrier on which an anode is situated and a separator situated between the anode and a cathode, the device comprising:
an elastic connector, the elastic connector elastically connecting the carrier and the separator, an action of force on the separator, caused by a change in volume of the anode, being capable of being absorbed by the electric connector.

13. The device as recited in claim 12, wherein the elastic connector is made of a plastic that has a closed porous region, or that has a porous region that is open only toward an interior of the anode and a non-porous region.

14. The device as recited in claim 13, wherein the elastic connector is formed in open porous fashion on a side facing the electrochemical cell.

15. The device as recited in claim 12, wherein the elastic connector is formed with a wave shape on a side facing the electrochemical cell.

16. The device as recited in claim 12, wherein a multiplicity of supporting elements are situated on a surface of the carrier, a distance between the respective supporting elements being from 10 to 100 μm.

17. The device as recited in claim 12, wherein a multiplicity of supporting elements are situated on a surface of the carrier, a distance between the respective supporting elements being from 10 to 20 μm.

18. The device as recited in claim 16, wherein a thickness of the respective supporting element has a thickness of the elastic connector in the compressed state.

19. The device as recited in claim 12, wherein an anode space formed between the carrier and the separator is filled with an electrolyte, the anode space being capable of being filled in a vacuum or under a reduced ambient pressure.

20. The device as recited in claim 12, wherein the elastic connector is respectively connected in media-tight fashion to the carrier and to the separator at their ends.

21. The device as recited in claim 12, wherein the elastic connector has a gap-shaped hollow space that is capable of expansion when there is an expansion of the anode and is capable of being compressed when there is a reduction in size of the anode.

22. A method for sealing an electrochemical cell including a carrier on which an anode is situated and a separator situated between the anode and a cathode, the method comprising:
elasticly connecting the carrier and the separator, an action of force on the separator, caused by a change in volume of the anode, being absorbed by the elastic connection.

23. The method as recited in claim 22, wherein an anode space formed between the carrier and the separator is filled with an electrolyte in a vacuum or under a reduced ambient pressure.
